(19) United States
(12) Patent Application Publication
(10) Pub. No.: US 2014/0324809 A1
(43) Pub. Date: Oct. 30, 2014

(54) SEARCH ENGINE CONTROL

(71) Applicant: Daniel Rajkumar, Leeds (GB)

(72) Inventor: Daniel Rajkumar, Leeds (GB)

(21) Appl. No.: 14/235,711

(22) PCT Filed: Jul. 27, 2012
(86) PCT No.: PCT/GB2012/051833

§ 371 Date: Jul. 14, 2014

(30) Foreign Application Priority Data
Jul. 28, 2011 (GB) 1113001.0

(51) Int. Cl. G06F 17/30

(52) U.S. Cl. CPC G06F 17/30864
USPC 707/706

(57) ABSTRACT

A method of controlling a search engine, the method comprising: causing a candidate search element to be displayed on a display having an associated pointing device; receiving input indicating selection of the candidate search element by the pointing device at an initial display position; receiving input indicating subsequent movement by the pointing device; and setting or revising search criteria for use by the search engine based on the subsequent movement of the pointing device relative to the initial display position.

This invention relates to a method, device, program and medium for controlling a search engine, and more specifically to a method, device, program and medium for controlling a search engine using a graphical user interface.

### BACKGROUND

In recent years, electronic data storage has become less expensive and more widespread, leading to vast quantities of information being stored. A challenge for users and potential users of this data is to extract useful information that is not relevant to the user's needs. To answer this challenge, various means of searching data have been provided, generally referred to as search engines. Search engines use various algorithms to find data matching a user's search query and present the data to the user. The query commonly includes terms that are to be present in matching data, but may also include terms that are to be absent from matching data. Other considerations, such as a creation date of the data can also be taken into account. Often search engines permit a user to refine search results, by adding additional search terms. Search engines often rank the data matching the query, using a wide variety of criteria. Typically, the aim of the ranking is to attempt to infer the most relevant data for the user. This may be based on previous selections from search results or on ratings by the same or other users.

Search engines are now commonly used for accessing information on the Internet, but are also used in many other situations and applications where data retrieval is performed.

US 2009/0187554 describes a content searching data processing system in which weighted search terms may be specified.

In some cases, formatting and providing a search query that produces useful results can be difficult for non-specialist users, and there is need for an interface that allows a user to interact intuitively with the search engine. Preferably, the interface should be provided in a graphical user interface, to improve user-friendliness. It is preferable that the user interface avoids unnecessary typing and makes input as quick and easy as possible from the user's point of view.

### BRIEF SUMMARY OF THE DISCLOSURE

In accordance with the present invention there is provided a method of controlling a search engine, the method comprising causing a candidate search element to be displayed on a display having an associated pointing device; receiving input indicating selection of the candidate search element by the pointing device at an initial display position; receiving input indicating subsequent movement by the pointing device; and setting or revising search criteria for use by the search engine based on the subsequent movement of the pointing device relative to the initial display position.

The subsequent movement may be indicated by maintaining selection of the candidate search element and moving the pointing device. The subsequent movement may terminate at a final display position determined by: deselection of the candidate search element, the subsequent movement causing the pointing device to leave a predetermined area of the display around the candidate search element, a path followed by the subsequent movement being determined to exceed a predetermined maximum length, or the subsequent movement causing the pointing device to reach or pass a boundary of the display. The subsequent movement may be defined by the initial display position and the final display position.

Setting or revising the search criteria includes setting or revising a treatment of the candidate search element. The treatment of the candidate search element may include one or more of: classing the candidate search element as relevant to a current user, increasing a relevance of the candidate search element for the current user, classing a group or class of search elements relating to or including the candidate search element as relevant to a current user, increasing a relevance of the group or class including the candidate search element for the current user, classing the candidate search element as not relevant for a current user, decreasing the relevance of the candidate search element for the current user, classing the candidate search element as not relevant for all users, decreasing a relevance of the candidate search element for all users. The setting or revising may include setting or revising a weight of the candidate search element based on an extent of the subsequent movement.

The method may further comprise causing a change in the appearance of the candidate search element on the display, such that the appearance of the candidate search element is indicative of the treatment of the candidate search element.

The method may further comprise determining a direction characterising the subsequent movement, wherein the setting or revising is based on the determined direction.

The method may further comprise: performing a search using the set or revised search criteria.

The pointing device may be a touch screen or a mouse.

The method may further comprise: receiving first search criteria; performing a first search based on the first search criteria; generating the candidate search element based on a result of the first search; storing information on the set or revised search criteria in association with information on the first search criteria; receiving subsequent search criteria; determining that the subsequent search criteria sufficiently match the first search criteria; performing a search according to the subsequent search criteria; and modifying, based on the stored information on the set or revised search criteria, at least one of: the search according to the subsequent search criteria, or a display of results according to the subsequent search criteria.

Another aspect provides a method of controlling a search engine, comprising: receiving a search result from the search engine, the search result including at least one hit and further including summary information for each hit; causing at least one hit and corresponding summary information to be displayed on a display; receiving input indicating selection of an element from the summary information using a pointing device in connection with the display; and revising search criteria for use by the search engine by revising the treatment of the selected element in a subsequent search by the search engine.

A further aspect provides a method of searching comprising: receiving first search criteria; performing a first search based on the first search criteria; receiving second search criteria that refine the first search criteria; storing information on the second search criteria in association with information on the first search criteria; receiving subsequent search criteria; determining that the subsequent search criteria sufficiently match the first search criteria; performing a search according to the subsequent search criteria; and modifying, based on the stored information on the second search criteria, at least one of: the search according to the subsequent search criteria, or a display of results according to the subsequent search criteria.

Also provided is a device to perform any of the above methods. Further provided is a computer program arranged to perform any of the above methods, or to cause a computer to operate as the device. A machine readable storage medium storing the computer program is also provided.

### BRIEF DESCRIPTION OF THE DRAWINGS

Embodiments of the invention are further described hereinafter with reference to the accompanying drawings, in which:

FIG. 1 shows a flow chart illustrating method according to an embodiment of the present invention.

FIG. 2 illustrates an example of a display of a search result.

FIG. 3 illustrates a selection of a candidate search element and subsequent movement of a pointing device.

FIG. 4 illustrates a case where a pointer is moved within an inactive region.

FIG. 5 illustrates a case where a pointer is moved past a boundary of a select region.

FIG. 6 illustrates a case where selection is released while a pointer is within the boundary of the select region.

FIGS. 7a and 7b show alternative schemes for determining a direction of movement of a pointer using four discreet directions.

FIG. 8 shows an example of a selection scheme in accordance with FIGS. 1 and 7a.

FIG. 9 illustrates an arrangement for determining a weighting based on a distance moved by a pointer.

FIG. 10 illustrates an embodiment combining the weighting regions of FIG. 9 with the regions illustrated in FIG. 8.

FIG. 11 illustrates a relationship between parent, child and grandchild searches according to an embodiment.

FIG. 12 illustrates a system for performing the methods according to the various embodiments described herein.

### DETAILED DESCRIPTION

The present invention has the aim of addressing at least some of the shortcomings of known search engines and search engine interfaces.

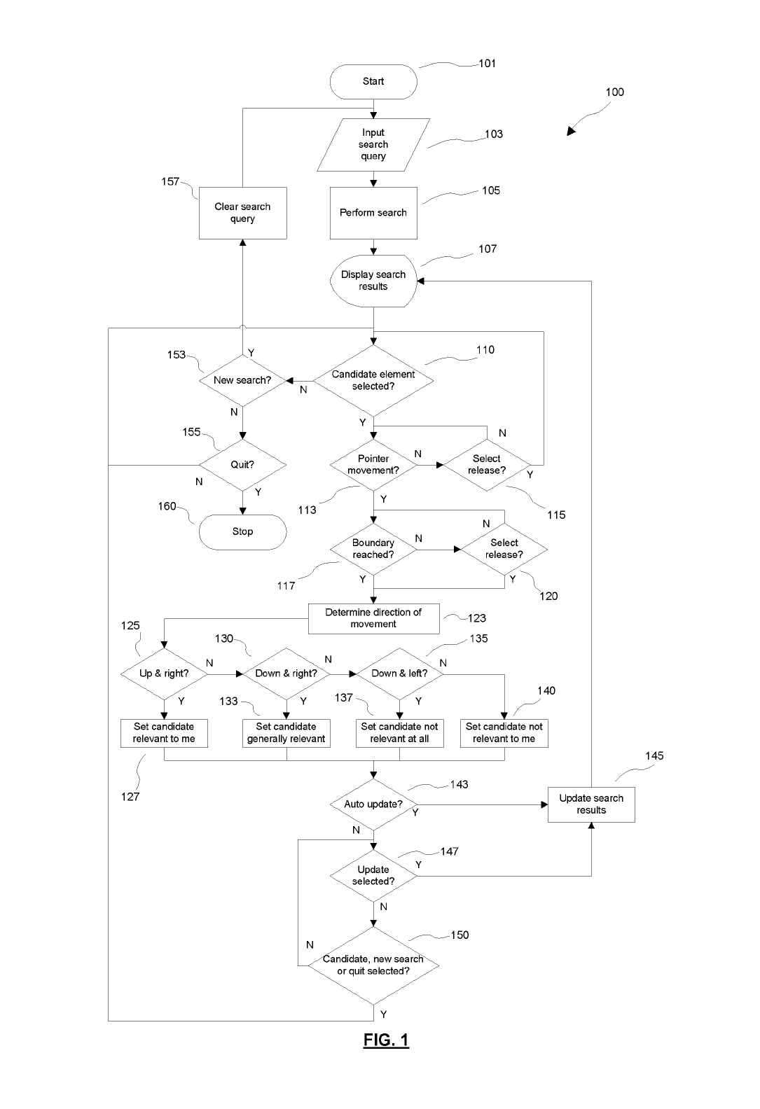

FIG. 1 illustrates a method 100 according to an embodiment of the present invention. The method starts at step 101, and at step 103 a search query is entered by the user. Typically, the search query includes words and/or phrases entered using a keyboard.

More generally, where the search engine has the capability, the search query could include images (image files), video (video files) and/or audio (audio files). Other types of input that can be accepted by the search engine may also be input. The term “search element” is used to refer to the various inputs that may for the basis of a search, such as text, words, phrases or images.

At step 105 the search elements are passed to the search engine, and the search is performed by the search engine. Numerous search engines and search algorithms are known, and any compatible search engine or search algorithm could be used with the present invention.

Typically the search will be performed on a predetermined set of data, which could be, inter alia, the files on a local hard drive or a collection of catalogued web pages. The set of data will normally include a number of distinct files, documents, web-pages, etc. that are referred to herein as data elements. In a simple example of a search, a data element will be considered to meet the search criteria, as defined by the search query, if the search elements are present in the data element. Data elements that meet the search criteria is referred to as a “hit”. Depending on the search engine and search query, a data element that only partially matches the search criteria may be considered to be a hit. In some embodiments, hits may be rated for relevance based on degree of matching with search criteria and/or other factors, such as user ratings. The search query may also specify that one or more search elements must not be present in a data element if the data element is to meet the search criteria. The search query may also include filters, for example omitting certain types of document. The search query may include default search elements and/or filters that are not provided by the user, for example to exclude or reduce the relevance of documents in a foreign language.

At step 107 the result of the search is received from the search engine and is displayed on a display device. According to the present embodiment, the display device is an LCD touch screen. FIG. 2 illustrates an example of the display of the result of the search. According to the present embodiment, the search result comprises one or more “hits”. The hits 210a, 210b, 210c are listed, and with each hit is provided a title 215a, 215b, 215c, summary text 220a, 220b, 220c. According to the present example, the search is being performed on pages from the Internet, and the summary text is a snippet. Snippets are well known to the skilled person, and can be generated using content in a Description meta tag of the web-page to be summarized. Other methods for generating summary text are well known to the skilled person, and could be incorporated into the present embodiment. More generally, summary information could be used in place of summary text, and may include images, for example.

According to the present embodiment, a location 230a, 230b, 230c of the data element is provided. In the case of a web-page, the location may take the form of a Uniform Resource Locator (URL), and in the case of a locally stored document, the location could be the path and filename of the document, for example.

Other information may be displayed with the search results. For example, as illustrated in FIG. 2, the search terms already used 240 may be displayed, and it may be possible to enter further terms using a keyboard, for example. Other search criteria may also be displayed, as indicated by 245. It may be possible to adjust search criteria such as the type of content searched for 250 or the origin of the content 255. Words (or other search terms) that have been assigned a weighting, as explained in more detail below, may also be displayed. None is displayed in FIG. 2, but 260 indicates where such words would be displayed.

At step 110 a check is performed to determine whether a user has selected a candidate search element. In the example of FIG. 2 the candidate search elements are the individual words in the summary text. In this embodiment, the user contacts the touch screen with a finger or stylus at the point of the screen at which the word is displayed.

In some embodiments, some or all of the words in the summary text may be grouped into terms of two or more associated words, and these terms may be selected in a corresponding manner. Some embodiments may permit two or more words in the summary text to be highlighted prior to selection in order to permit selection of terms comprising the highlighted words. Highlighting can be achieved using a touch screen, for example, by touching the screen at an “empty” location and moving the point of contact with the screen to pass over the word to be highlighted while retaining contact with the screen. When one of the highlighted words is subsequently selected, all of the highlighted words are then considered to be selected.

Selection is also possible where the summary information includes images, the images being selected in an analogous manner to words or phrases.

The location 230a, 230b, 230c may also be selectable as a candidate search element, in a similar manner to a word of summary text.

If no selection is detected, the method moves to step 153, described below. If a candidate search element is selected, the method advances to step 113.

In step 113 it is determined whether the pointer (in this case the finger or stylus in contact with the touch screen) has been moved. If it is determined that the pointer has not moved, and at step 115 it is determined that the selection has been released (e.g. by removing the finger or stylus from contact with the touch screen) it is determined that no action should be taken, and processing returns to step 110 to await another selection event. On the other hand, if the pointer is determined at step 113 not to have moved, but the selection has not been released (i.e. the finger or stylus maintains contact with the touch screen, but has not moved across the surface of the touch screen (determined at step 115), the method returns to step 113 to await movement of the pointer.

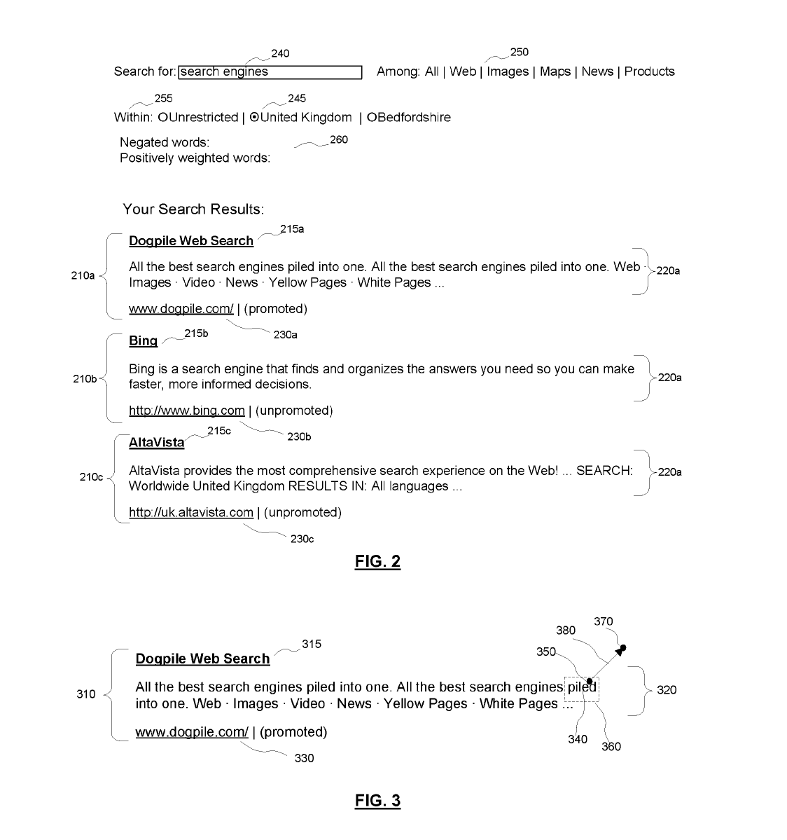

FIG. 3 illustrates a selection of a candidate search element and subsequent movement of a pointing device. One of the displayed (step 107) hits 310 is illustrated. The display shows a title 315, indicating the data element, associated with summary information 320 (here summary text) and location information 330 (here a URL). In the example of FIG. 3, the candidate search element to be selected 340 (here word piled) of the summary information is to be selected by the user. In this example, each of the words of the summary text is a candidate search element. The user touches the touch screen at point 350 and according to the present embodiment it is determined that the user has touched the screen within a pre-determined area surrounding the candidate search element (word piled). The boundary 360 of the predetermined area is illustrated fin FIG. 3, but is not necessarily displayed on the display device. The display may be altered to provide a visual indication of the selection. An audible indication of the selection may be provided through speakers, headphones or the like. The positive determination that a selection has been made advances the method from step 110 to step 113.

While maintaining the contact with the touch screen, the user moves the point of contact to point 370, following trajectory 380. This movement is detected and the method proceeds to step 117. In the current example it is assumed that point 370 is within a selection boundary (explained further below), and so the method advances to step 120.

At point 370 the user removes the contact with the touch screen, and so releases the selection. This is detected, and the method proceeds to step 123, where it is determined that the direction of movement was up and to the right.

The following provides a more detailed description of steps 110 to 123.

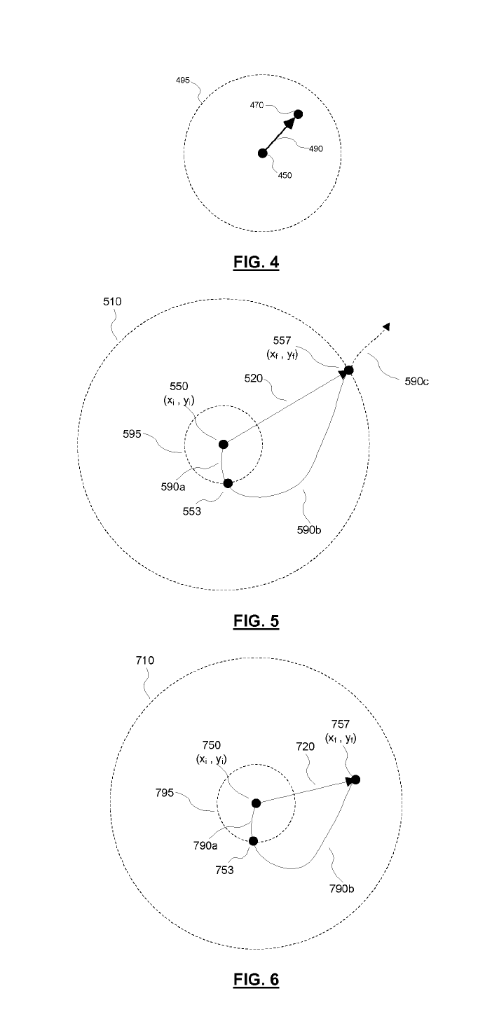

At step 110 a check is performed to determine whether a candidate search element has been selected. If no selection is detected, the method waits until a selection is made, a new search is initiated (step 153) or the user quits from the method (step 155). When a selection is detected, the method advances to step 113. In step 113 it is determined whether the pointing device has moved while the selection is maintained. According to a preferred embodiment small movements of the pointing device are disregarded. FIG. 4 shows the case in which a user has touched the touched screen at initial position 450, initiating a selection of a candidate search element (not shown). While retaining contact with the touch screen, the user makes a small movement with their finger, so that the point of contact with the touch screen moves to 470 along trajectory 490. The movement of the point of contact remains within a predetermined region 495 that includes the initial position 450. The predetermined region is a small region within which movements of the pointer (point of contact) are disregarded. Accordingly, the movement to point 470 is determined to be insufficient and the method progresses to step 115. At step 115 it is determined whether the selection of the candidate search element has been released, for example by the user removing their finger from contact with the touch screen. If the contact has been released, the method returns to step 110 to await a further selection event. If the selection is determined to be maintained (not released), the method returns to step 113, and contuse to loop between steps 113 and 115 until the selection is released or the pointer moves beyond the predetermined region (referred to hereinafter as the inactive region). In the present example the inactive region is circular and centered on the initial point 450, although other possibilities exist. For example, the inactive region may be a rectangle centered on the center of the selected candidate search element.

FIG. 5 illustrates a user interaction with the touch screen in relation to steps 117, 120 and 123. At step 117 it is determined whether the pointer has reached the boundary of, or moved outside of, a second predetermined region. This predetermined region is referred to as a select region, and is delimited by a selection boundary. FIG. 5 shows an initial point 550, where a selection is made by a user touching a touch screen. The point of contact is moved along the trajectory 590 (590a, 590b and 590c). After the trajectory passes the inactive region boundary 595 at point 553, step 117 checks whether the trajectory has passed the selection boundary 510 (the boundary of the select region). Along portion 590b of trajectory 590 this check is negative and the method checks at step 120 whether the selection has been released. The present example assumes that selection is not released and the method loops between steps 117 and 120 until the boundary of the select region is reached or crossed, or the selection is released.

In the current example, the trajectory meets the boundary 510 of the select region at point 557. The trajectory then continues along 590c. The trajectory meeting the selection boundary at point 557 causes the method to advance to step 123. The point 557, where the trajectory crosses the selection boundary and exits the select region is designated as the final position, and is taken to be the end of the trajectory for the purpose of determining the input in relation to the selection.

FIG. 6 shows an alternative example of a user interaction with the touch screen in relation to steps 117, 120 and 123. The user contacts the touch screen at initial point 650 to select a candidate search element (step 110). The user then moves the point of contact with the touch screen along trajectory 690a, maintaining the contact and the selection, so that the point of contact (pointer) passes the inactive region boundary 695 at point 653. This is detected at step 113 and the method proceeds to point 117. The user maintains the contact and moves the pointer along trajectory 690b to point 657. As the pointer moves from point 653 to point 657, the method loops between steps 117 and 120. At point 657 the user removes the contact with the touch screen, releasing the selection. This is detected at step 120, and the method proceeds to step 123. According to this example, point 657 is designated the final position. This is analogous to the designation of the final position in the example of FIG. 5, with the exception that the final point 657 is determined based on the user releasing the selection within the select region, rather than the trajectory crossing the selection boundary 510, 610.

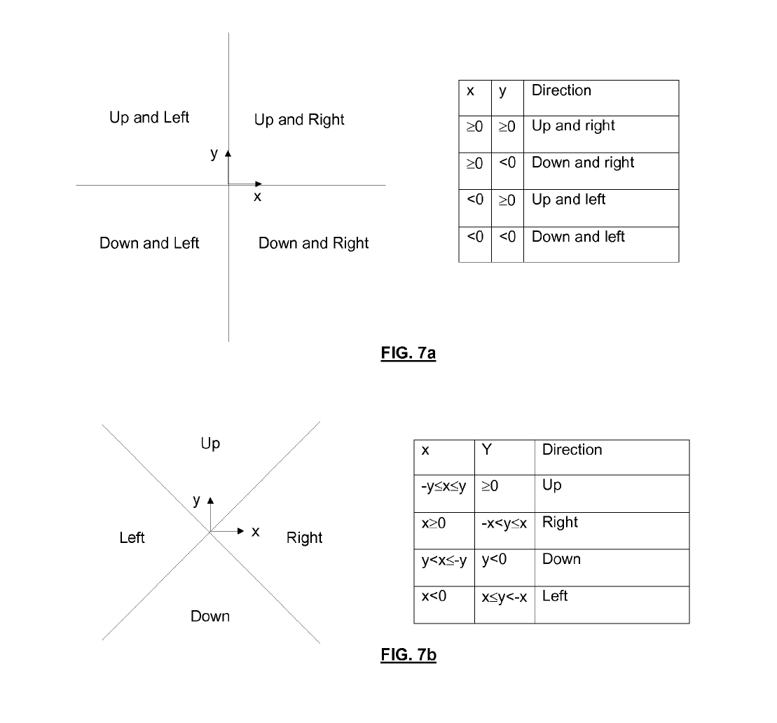

In step 123 a displacement vector 520, 620 is calculated as Δ=(Δx, Δy)=(x_{f}−xᵢ, y_{f}−yᵢ), where the initial position 550, 650 is (xᵢ, yᵢ) and the final position 557, 657 is (x_{f}, y_{f}). Here it is assumed that positions on the display may be represented by Cartesian coordinates having their origin at the bottom left of the screen. Other schemes for representing display positions would be known to the skilled person, and could be incorporated into the present invention. From the displacement vector, A, a representative direction of the movement is derived. Example schemes using four directions are shown in FIGS. 7a and 7b. Alternative schemes could be used, for example having more or fewer distinct directions than 4.

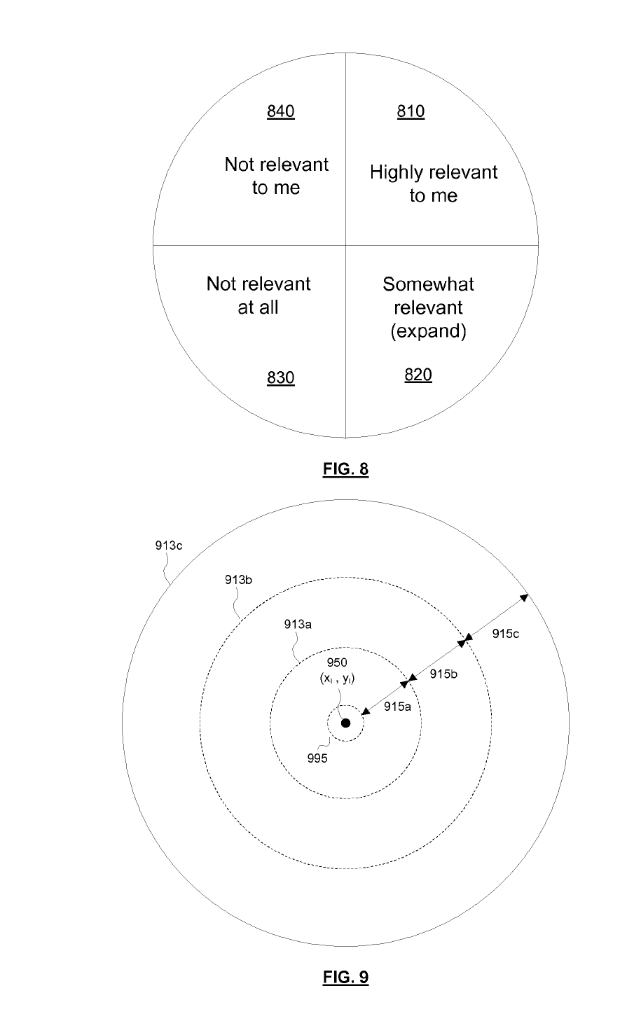

Steps 125, 130 and 135 each determine whether a particular direction has been determined in step 123, according to the scheme of FIG. 7a. These steps respectively check for “up and right”, “down and right” and “down and left”. If each of these determinations is negative, it is deduced that “up and left” was determined at step 213. In steps 127, 133, 137 and 140 the search criteria are modified in accordance with the determination of step 123. FIG. 8 shows an example of a selection scheme in accordance with FIGS. 1 and 7a.

FIG. 8 shows four quadrants, each corresponding to an update action, that is to be applied to a selected candidate search element that has a final position in that quadrant (or more generally region). The four quadrants in this example are “Highly relevant to me” 810, “Somewhat relevant (expand) 820, “Not relevant at all” 830 and “Not relevant to me” 840. These quadrants respectively correspond to “Up and right”, “Down and right”, “Down and left” and “Up and left” determinations in the scheme of FIG. 7.

If, at step 125, it is determined that the direction of movement of the pointer was “Up and Right”, this corresponds to “Highly relevant to me” 810 and the method moves to step 127. This step updates the search criteria to reflect that the selected candidate search element is considered by the user to be relevant. In one embodiment this results in the candidate search element being added to the search criteria in a manner that, in a subsequent search, only data elements that include the selected candidate search element will be considered to match the search criteria. Alternatively, where the search engine applies weightings to search elements, the selected candidate search element may be assigned a positive weighting, where a positive weighting implies improved relevance of data elements including that search element. The weighting may be a default value. Where the selected candidate search element is already a search element, the weighting of the search element may be increased, to improve the relevance associated with data elements including this search element. For example if a user searches (step 105) for “intellectual property” hits may relate to, inter alia, patents, copyright and trademarks. The user may be primarily interested in patents, and so would select, using a pointer, (step 110) the word “patent” from summary text of one of the hits and move the pointer up and to the right to a final position (step 117 or 120). The method would advance through steps 123 and 125, and at step 127 the word “patent” would be added to “intellectual property” as a search term for a subsequent search. If the initial search had included the terms “intellectual property patent” the weighing of the term “patent” would be increased relative to the other search terms.

If, at step 125, the direction of movement of the pointer is determined not to correspond to “Up and right” processing moves to step130, where it is determined whether the direction of pointer movement is “Down and right”. If this determination is positive, processing moves to step 133. Step 133 indicates that the selected candidate search element is “generally relevant”. This indicates that the selected candidate search element relates generally to the subject matter of interest to the user, but the selected candidate search element itself need not be present. In this case, the search criteria are modified to require (or increase the weight of) a number of elements in a predetermined group of class related to the selected candidate search element as alternatives. For example, if in the above example search for “intellectual property”, the user was interested in intellectual property relating to the medical field, rather than patents, the user might, in steps 113 to 120 select the term “medical” from summary text of a hit and move the pointer down and to the right. The search criteria may then be updated for a subsequent search to require any one of the terms “medical, medicinal, therapeutic, health, pharmaceutical” in order for a document (data element) to match. The list of terms may be taken from a predetermined list of synonyms and related terms, such as a thesaurus. Other groups and classes are possible, and can be predetermined or generated on the fly according to predetermined rules. Where search criteria are weighted, the weight of search elements in a group or class may be increased by selecting a candidate search element associated with that class and moving the pointer down and right. The group and/or class preferably includes the selected candidate search element (for example “medical” was included in the list of terms added to the search query), but this is not required.

If at step 130 it is determined that the pointer was not moved down and right, the method proceeds to step 135. At step 135 it is determined whether the pointer was moved down and left. If this determination is positive, it indicates that the selected candidate search element is “Not relevant at all”. This means the candidate search element does not belong in the results for the current search criteria, and it should be excluded from future results for all users. This may be implemented by assigning a negative weight to this candidate search element for a subsequent search, and in addition to all searches having the same or similar search criteria to the current search. This negative weight would reduce a relevancy rating of any data element including this candidate search element. For example, if an initial search uses the terms “intellectual property patent” and the search result includes hits relating to “patent shoes”, the user may, in steps 110 to 140, indicate that the term “shoes” is not relevant at all. In any subsequent search, by any user, for “intellectual property patent”, data elements including the term “shoes” would have a reduced relevancy.

If the determination at step 135 is negative, it is determined that the pointer movement corresponds to “Not relevant to me”, which means that the candidate search element may be relevant in certain circumstances, but in the context of the current search it is not relevant. The method moves to step 140, where the current search criteria are updated to exclude, or apply a negative weighting to, the candidate search element from subsequent results for users matching a profile (or aspects of the profile) of the current user (such as location, browser, language).

Adjusting the weighting of a candidate search element may involve updating an index that records correlations between search elements. The weighting affecting a correlation between the candidate search element and other search elements of the current search criteria.

Steps 127, 133, 137 and 140 relate to exemplary adjustments of the search criteria, but other adjustments or combinations are possible, as would be evident to the skilled person. Where references are made to positive or negative weightings, this may involve adjusting a current non-zero weighting positively or negatively. For example, applying a negative weighting to a candidate search element that is already strongly positively weighted may result in that candidate search element having a weighting that is still positive, but less so than previously.

After the search criteria have been revised in one of steps 127, 133, 137 or 140, the method moves to step 143, where it is determined whether the search result should be automatically updated. This information may be pre-set, and may be stored, for example by a cookie or a variable set in a user configuration file. In some embodiments the use or otherwise of automatic updating may be fixed, such that automatic updating always occurs or never occurs. In this case, it is not necessary to provide functionality for step 143, and processing may proceed directly to step 145 (with automatic updating) or step 147 (without automatic updating). Automatic updating has the advantage of providing feedback to the user with each revision of the search criteria without requiring the user to perform an additional operation to receive the revised search result. On the other hand, where a noticeable period of time is required to revise the search and display revised search results, it may be preferable not to automatically update the search results. This allows the user to make a number of changes to the search criteria without waiting for the revised result to be displayed after each change.

Where automatic updating is to be used, the method proceeds to step 145, otherwise, the method loops between steps 147 and 150, waiting for the user to input a request to update the search, select another (possibly the same) candidate search element, initiate a new search (clear the current search criteria) or quit searching.

Where the user selects an update of the search (possibly by selecting a “search button” on the graphical user interface), the method proceeds to step 145 via step 147. Where the user selects another option, the method moves to the loop formed by steps 110, 153 and 155, and the appropriate processing for the user's selected option is carried out.

In step 145 the search results are updated in accordance with the updated search criteria, and processing returns to step 107, where the updated search results are displayed, and may be further refined by repeating the steps described above.

With regard to the loop formed by steps 110, 153 and 155, when the method reaches step 110, the method cycles between these steps until the user takes one of the actions that are checked for in these steps. Step 110 relates to selection of a candidate search element, and is described above. Where no such selection is detected, the method moves to step 153, where it is determined whether the user has selected a new search. This indication may be by selecting a button icon on the graphical user interface. Where the user selects a new search, the search criteria are cleared (step 157) and the method returns to step 103 to begin a new search.

Where the user has not selected a new search, the method moves to step 155 to determine whether the user has selected to quit searching. Again, this selection may be made by selecting an appropriate button icon on a graphical user interface. If it is determined that the user has not selected to quit searching, the method returns to step 110 to continue waiting for user activity. On the other hand, if the user has selected to quit searching, the method terminates at step 160.

It is to be noted that the evaluation of the movement of the pointer carried out in steps 123, 125, 130 and 135 depends only on the relative displacement between the initial and final positions. That is, the evaluation is based on features of the trajectory, and aside from the possible use of the initial and final positions in determining the trajectory, the initial and final positions themselves do not contribute to the evaluation and interpretation of the movement. This form of input and evaluation is referred to herein as a swipe or a swipe action. A swipe differs from the well known drag and drop feature commonly found in graphical user interfaces, since the evaluation of a drag and drop event is based entirely on the display position at which the drop occurs. In contrast, a swipe is dependent on the relative positions of the initial and final positions, and is essentially independent of the absolute position on the display of the final position, beyond the possible use of the final position to determine the relative displacement between the initial and final positions. On the other hand, evaluation of drag and drop operations are essentially independent of the initial position and the relative displacement between initial and final positions.

The swipe action provides a quick and intuitive method of adjusting search criteria. In particular, the user is required to merely select a displayed candidate search element and move a pointer in one of a number of predetermined directions. The user is thus not required to type in text or be familiar with particular syntax for interacting with the search engine. Furthermore, the user is not required to move the pointer to a fixed location on the display, which requires additional coordination and precision that may add a small but noticeable time to the time required to carry out the action.

In an alternative embodiment, similar to that of FIG. 1, the pointer movement detected in step 113 may be used to indicate a degree to which the selected candidate weighting should be changed. An exemplary arrangement is illustrated in FIG. 9. The initial position of the selection is point 950. If subsequent movement of the pointer is within an inactive boundary 995, it is determined that no movement has occurred (corresponding to a “No” determination in step 113 of FIG. 1). If the pointer moves outside of inactive boundary 995 and the section is then released by the user, in a step not illustrated in FIG. 1, it is determined whether the final position (at which the selection is released) is within one of a plurality of non-overlapping predetermined regions. Preferably, the predetermined regions are defined relative to the initial position, and may be concentric. In FIG. 9 the predetermined regions are denoted 915a, 915b and 915c, and are delimited by concentric circles 913a, 913b and 913c, which are centered on the initial position. The predetermined regions correspond to a degree to which the relevant weighting should be applied to the candidate search element. In the example of FIG. 9, the region 915a corresponds to applying a weak weighting adjustment, region 915b a medium weighting adjustment, and region 915c a strong weighting adjustment.

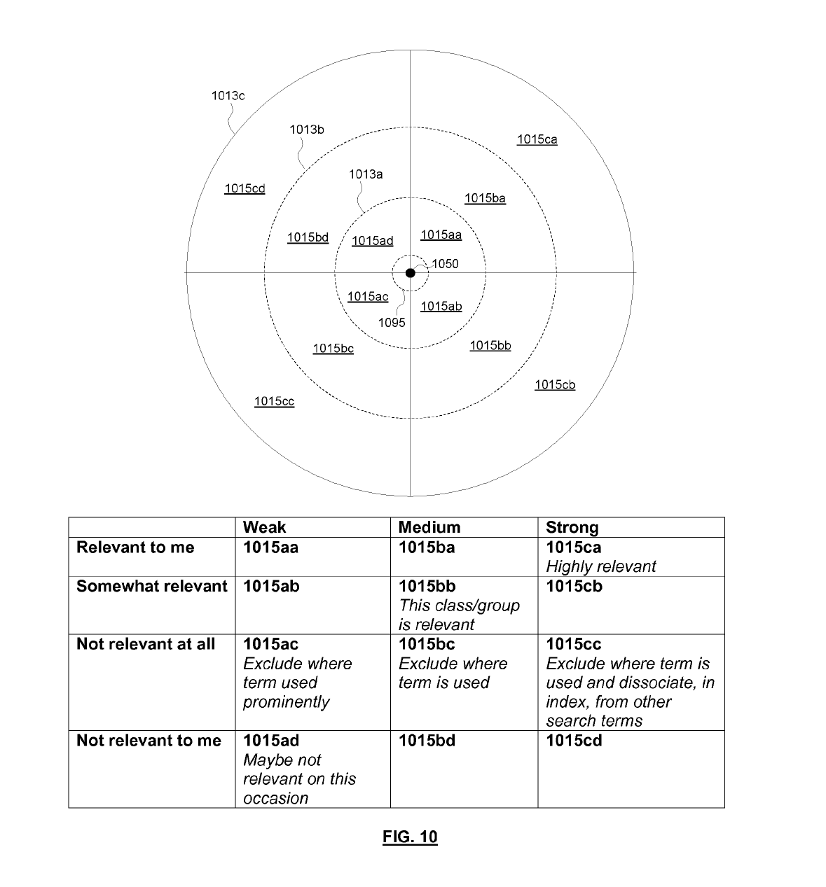

FIG. 10 illustrates an embodiment combining the weighting regions of FIG. 9 with the regions illustrated in FIG. 8. The table in FIG. 10 indicates the meaning associated with each region, and provides some examples of the implementation or interpretation when a candidate search element is selected and the pointer is moved to that region.

In some embodiments the outermost boundary 913c is coincident with the selection boundary 510, 710, such that a pointer movement beyond the outermost boundary 915c causes the final position to be designated at the point where the trajectory of the pointer crosses the outermost boundary 915c. In other embodiments, neither the outer boundary 913c nor the selection boundary 510, 710 is provided, and the outermost region 915c extends to the boundaries of the display device.

In another embodiment, a weighing of the selected candidate search element is changed by an amount proportional to a length of a vector joining the initial and final positions. According to this embodiment, rather than determining which of the pre-defined concentric regions of FIG. 9 includes the final position, the length of the vector between the initial and final positions is determined. Using the notation introduced in relation to step 123, for example, the length of the vector would be |Δ|=√(Δx²+Δy²)=√((x_{f}−xᵢ)²+(y_{f}−yᵢ)²). The weighting adjustment applied to the selected candidate search element would then be α|Δ|, where α is a predetermined scaling value. In some arrangements, the weighting adjustment may have a non-linear relation to the length of the vector. The weighting adjustment may be added to a current weighting to produce a new weighting, or may be multiplied by the current weighting to produce a new weighting (assuming that the current weighting is not zero).

In some embodiments, if a pointer is moved outside of an inactive region and, while the selection is maintained, returned to the inactive region, where the selection is then released, this may be treated in the same manner as when the selection is released without leaving the inactive region. In some embodiments, the inactive region need not be provided. In this case, any detectable movement of the pointer will caused the method to move from step 113 to step 117 of FIG. 1, for example.

In some embodiments the select region and selection boundary are not provided. In this case, the selection will not be released based on a distance from the initial position. For example, in FIG. 1 step 117 would be omitted and the method would move directly from step 113 to step 120. A “No” decision in step 120 would loop back to step 120.

In some embodiments having a select region and a selection boundary, it may be unnecessary to determined whether a selection has been released. In this case, the final position may be determined by the point at which the pointer trajectory crosses the selection boundary. For example, if the user releases the selection before the selection boundary is reached the method may proceed as if the pointer had not moved outside of an inactivity region. In FIG. 1 this would correspond to the “Yes” decision in step 120 returning to step 110. Where the selection boundary is set sufficiently close to the initial position, the swipe may seem to the user to be a directional flick.

In a further embodiment, the selection boundary may coincide with the edge of the display, such that the final position is automatically designated if the pointer reaches the edge of the display. This may be implemented by defining a selection boundary within, and at a small, fixed distance from, the edge of the display.

In the embodiments according to the present invention, various visual or audible indications may be provided to the user. For example, a selected candidate search element may be highlighted. The appearance (e.g. colour or size) of candidate search elements in the display of the search result may reflect a respective associated weight and/or search action (if already set). When a pointer is moved following a selection of a candidate search element, the candidate search element may be moved with the pointer. In some embodiments, a “ghost” version of the selected candidate search element may be moved with the pointer while the candidate search element itself does not move. The ghost version may be translucent or displayed in muted colours relative to the original candidate search element. The appearance of the selected candidate search element, or its ghost, may be changed to reflect a weight or search action will be assigned to the candidate search element if the selection is released without further movement. When a search is updated, previously selected search elements may be listed, and may be displayed in a manner that indicates their currently assigned weights and/or search actions. This is particularly useful for adjusting the weight or search action associated with candidate search elements that are not present in the summary information of the revised search.

According to embodiments of the present invention, elements of summary information form candidate search elements, and may be selected by a user to refine search results. This reduces the need for the user to enter terms using a keyboard, for example, and provides a simple, intuitive method allowing a user to interact with a search engine. This is also simple to implement, and does not require significant computing resources to produce candidate search elements.

In some embodiments location information may be used as a candidate search element. Location information may be a URL or a location of a file on a local storage medium. According to preferred embodiments, the initial position of the pointer within the location information element when the selection is made determines the portion of the location element that is to be selected. For example, if the location information element (candidate search element) is the URL “http://www.epo.org/law-practice/case-law-appeals.html” the selection could be considered to be “www.epo.org/law-practice/” or “www.epo.org” depending on the position within the display of the URL that is initially selected by the user (e.g. within the region of “/law-practice/” in the former case or to the left of this region in the latter case). Depending on the search action that is indicated a subsequent search may increase the weight of web pages within the selected domain or path, may search only within the selected domain or path, may reduce the weighting of web pages within the selected domain or path, or may exclude all web pages within the selected domain or path.

The above embodiment included an LCD touch screen as a display device and as a pointing device. However, various alternatives would be readily apparent to the skilled person. The display device could be embodied by a cathode ray tube (CRT) monitor, a plasma screen, a projector or an electrophoretic display. The pointing device may be embodied by a mouse, trackball, touchpad or a wand-like pointer (a Wii remote™, for example). For example, when using a mouse, selection of a candidate search element may be effected by pointing a mouse cursor at the candidate search element to be selected and depressing a button (e.g. a left mouse button on a standard mouse). Swiping may be achieved by subsequently moving the mouse while retaining the mouse button in a depressed state.

The above embodiments describe specific arrangements for determining whether a swipe action has occurred. However, variations on this could be determined by the skilled person. For example, in one embodiment the loop between 113 and 115 it could additionally include a step of checking whether a selection had been made and maintained without movement of the pointer for longer than a threshold time period, and if the check is positive, the selection could be timed-out by deselecting the selected candidate search element, regardless of the state of the pointing device (e.g. even if a finger retains contact with a touch screen).

In some embodiments, an additional check could be made in the loop between steps 117 and 120 to automatically release the selection after a predetermined period of time looping between steps 117 and 120. The period of time could be counted from the time of the selection of the candidate search element or could be counted from the time the trajectory passes outside the inactive region, for example. Following this time out the method could be returned to step 110 or may continue to 123, as if the user had released the selection. Additionally or alternatively, the loop between steps 117 and 120 could be exited if it is determined that the total length of the trajectory traced by the pointer has exceeded a threshold value. For example, in the case that a user moves the pointer in a circle or spiral within the select region.

Embodiments of the present invention may be used in conjunction with a search engine that is arranged to receive first search criteria, present results of a search based on the first criteria, receive second search criteria that modify the first search criteria, and modify weightings or rankings associated with the first search criteria, or subsequent searches based on the first search criteria, the modification of the weightings or rankings being based on the second search criteria. This allows a “mind map” of a user's thought process during searching to be built up over time and successive searches, enabling the refinement of the presentation of results in subsequent searches. For example, a user may initially search for “French translation”, and these terms would form the first search criteria. After the results of the search are displayed, the user may refine the search by searching for “French translation professional NOT automated”, being the second search criteria. Here, NOT indicates that a term is undesirable. This refinement of the search would be stored in relation to the original search criteria, such that a subsequent search for “French translation” would attach a greater importance to hits that also matched “French translation professional NOT automated”. The search engine would thus learn to present hits that match an expected next refinement of the search. This has the effect of the results obtained by a user being refined by the actions of a previous user.

FIG. 11 illustrates schematically a first search (termed a parent search 1110), a second search that refines the first search (termed a child search 1120), and a third search that refines the second search (termed a grandchild search 1130). The search terms of the child search 1123 are used to modify the weighting 1115 of the results of subsequent searches using the parent search terms 1113. This modification of the weighting 1115 is illustrated by a dashed arrow. In preferred embodiments, the grandchild search terms 1133 are used to modify the weighting 1115, 1125 of results in a subsequent search using the child search terms 1123 and/or the parent search terms 1113.

The mind map may be implemented in various ways that would occur to the skilled person. For example, search criteria 1133 of a child search 1130 may be indexed by or associated with the parent search terms 1113, such that, if a subsequent search is performed having the same search criteria 1113 as the parent search 1110, the previous child search criteria 1123 will be noted, and any hits in the subsequent search that would also be hits for the previous child search 1120 are given an increased or modified weight or ranking. Whether or not hits of the subsequent search are also hits of the previous child search 1120 may be determined in a single search operation, applying appropriate weights to the search criteria (e.g. a reduced weight to the criteria of the previous child search), or may be performed in stages, such as a first search using the search criteria of the subsequent search, and a second search, within the results of the first search, using the previous child search criteria 1123, to adjust the ranking or weighting of the search results.

In some embodiments, when the subsequent search is similar but not identical to the previous parent search 1110, the search engine is arranged to adjust the weighting of the search results based on the child search criteria 1123 associated with the previous parent search 1110. Preferably, the importance (strength of weighting) associated with the child search criteria 1123 depends on the degree of similarity between the previous parent search criteria 1113 and the subsequent search criteria.

In some embodiments, grandchild search criteria 1133 may be stored in relation to parent search criteria 1113 with a weaker weighting than that of child search criteria 1123. In other embodiments, child and grandchild search criteria 1123, 1133 have equal weighting. Preferably, where multiple users repeat similar refinements, the weight associated with those refinements increases. For example, if the same parent and child searches 1110, 1120 are performed by multiple users, the weight of the child search criteria 1123, associated with the parent search 1110 will increase. In some embodiments, child search criteria 1123 are stored, but only affect the results of subsequent searches after use of the child search criteria 1123 has been recorded a threshold number of times (e.g. when a particular child search 1120 has been used to refine a particular parent search 1110 on at least five occasions).

The embodiment of FIG. 8 can be used particularly advantageously with the search engine of the present embodiment, since the embodiment of FIG. 8 allows a user to distinguish between search refinements that are likely to be unique to that user (not relevant to me and highly relevant to me), and search refinements that are likely to be relevant to all users (not relevant at all). In this case, an indication by a user that a term is “not relevant to me” or “highly relevant to me” would result in the search criteria being revised, but would not register the child search (or the aspects of the child search indicated as relevant only to the user) in relation to the parent search, such that subsequent searches using the parent search criteria would not be affected by the previous search refinements indicated as only relevant to the previous user. In contrast, a term indicated as “not relevant at all” in a child search would be registered in relation to the parent search, and affect subsequent searches matching the parent search. In FIG. 8, an indication that a term is “somewhat relevant” might or might not affect subsequent searches, depending on the implementation.

The search engine described above may be used advantageously with the interface according to embodiments of the invention. In particular, embodiments of the invention provide an intuitive interface that encourages a user to refine the search criteria. Moreover, in embodiments in which the search is automatically repeated or refreshed after a candidate search element is moved, each step of the search refinement can be tracked and used to build a mind map that reflects the user's progression from a vague, broad search, to a narrow, focused search.

The parent, child and grandchild generations described above could be extended to any number of ancestor or descendant generations.

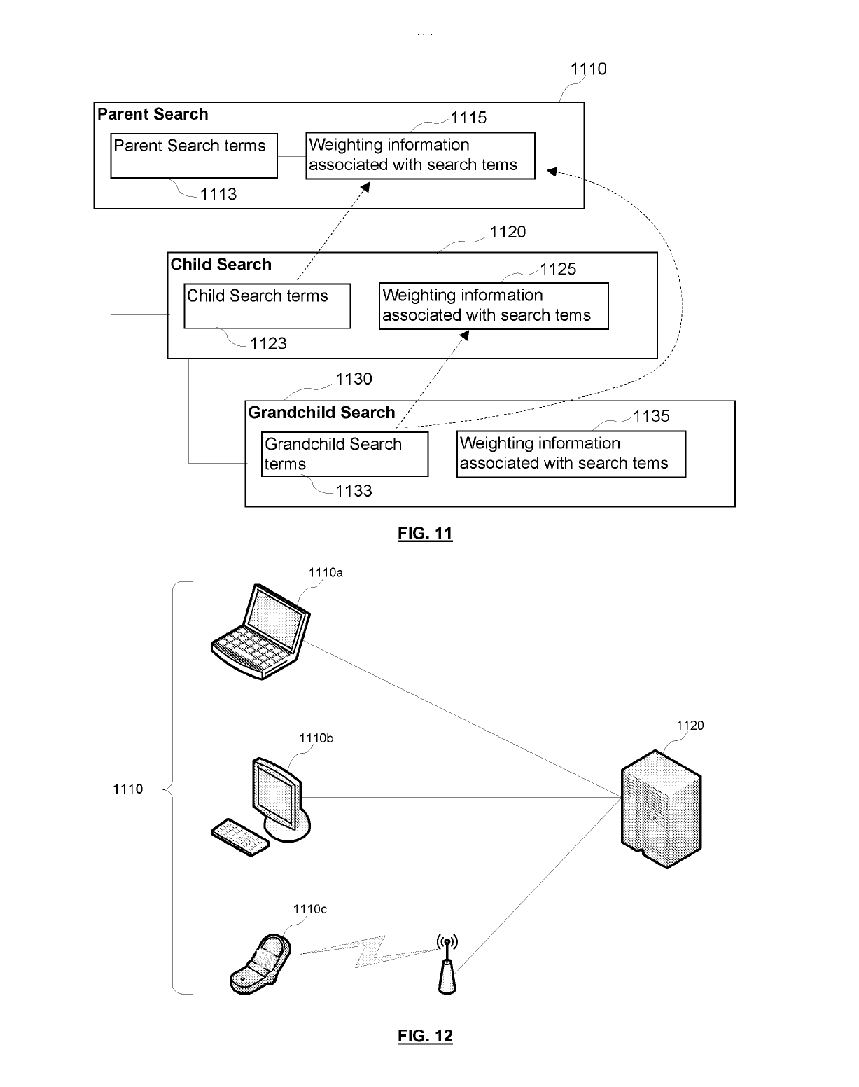

FIG. 12 illustrates a system for performing the methods according to the various embodiments described herein. The system includes one or more user terminals 1210, represented here as a laptop computer 1210a, desktop computer 1210b, or mobile telephone 1210c. The user interacts with a user terminal 1210 in order to communicate with a server 1220 via a network such as the Internet. The communication may be via wired or wireless connections. The methods according to embodiments of the invention may be performed entirely by the user terminal 1210, or entirely by the server 1220. In some cases, the methods may be performed partially by the user terminal and partially by the server. In a preferred embodiment, the user terminal 1210 indicates to the server 1220 that a search is to be performed, and the server causes information to be displayed by the user terminal by sending the information via the network in a format that can be interpreted and displayed by the user terminal. The user of the terminal may then interact with the terminal 1210 via a pointing device, and the user terminal 1210 provides an indication of this interaction to the server 1220. The server 1220 receives this indication as input. The server then sets or revises search criteria for a subsequent search.

In another embodiment, the user terminal 1210 causes information received from the server 1220 to be displayed on a display. The user interacts with the user terminal 1110 via a pointing device, and the user terminal 1210 receives an indication of this interaction as input. The user terminal then sets or revises search criteria for a subsequent search and forwards these search criteria to the server 1220 for use in a subsequent search.

In some embodiments, a server is not required, and the searching, as well as interaction with the search engine, is performed entirely by the user device 1210. This may be advantageous when the search is for content on a local storage medum.

The functionality of the search engine and/or the functionality of the interaction with the search engine (e.g. a graphical user interface) may be implemented by means of computer software (a computer program) or hardware. A computer program providing this functionality may be provided on a computer readable storage medium, such as a magnetic disc, optical disc, solid state storage medium (such as flash memory) or RAM.

Throughout the description, reference has been made to search terms and search criteria. In most cases these terms are interchangeable. In some cases, “search term” has used to refer to words or phrases of text, while search criteria refers more generally to any property that can be used as a basis for a search. However, the use of “search term” does not generally imply that the relevant aspect of the embodiment is limited to searching for words or phrases of text. Although “criteria” is plural, the term “search criteria” is intended to include the case where a single requirement is defined for a matching document.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of controlling a search engine, the method comprising:
causing a candidate search element to be displayed on a display having an associated pointing device;
receiving input indicating selection of the candidate search element by the pointing device at an initial display position;
receiving input indicating subsequent movement by the pointing device; and
setting or revising search criteria for use by the search engine based on the subsequent movement of the pointing device relative to the initial display position.

2. The method of claim 1, wherein the subsequent movement is indicated by maintaining selection of the candidate search element and moving the pointing device.

3. The method claim 2, wherein the subsequent movement terminates at a final display position determined by:
deselection of the candidate search element,
the subsequent movement causing the pointing device to leave a predetermined area of the display around the candidate search element,
a path followed by the subsequent movement being determined to exceed a predetermined maximum length, or
the subsequent movement causing the pointing device to reach or pass a boundary of the display.

4. The method of claim 3, wherein the subsequent movement is defined by the initial display position and the final display position.

5. The method of claim 1, wherein the setting or revising the search criteria includes setting or revising a treatment of the candidate search element.

6. The method of claim 5, wherein the treatment of the candidate search element includes one or more of:
classing the candidate search element as relevant to a current user,
increasing a relevance of the candidate search element for the current user,
classing a group or class of search elements relating to or including the candidate search element as relevant to a current user,
increasing a relevance of the group or class including the candidate search element for the current user,
classing the candidate search element as not relevant for a current user,
decreasing the relevance of the candidate search element for the current user,
classing the candidate search element as not relevant for all users,
decreasing a relevance of the candidate search element for all users.

7. The method of claim 5, wherein the setting or revising includes setting or revising a weight of the candidate search element based on an extent of the subsequent movement.

8. The method of claim 5, further comprising causing a change in the appearance of the candidate search element on the display, such that the appearance of the candidate search element is indicative of the treatment of the candidate search element.

9. The method of claim 1, further comprising determining a direction characterising the subsequent movement,
wherein the setting or revising is based on the determined direction.

10. The method of claim 1, further comprising:
performing a search using the set or revised search criteria.

11. The method of claim 1, wherein the pointing device is a touch screen or a mouse.

12. The method of claim 1, further comprising: receiving first search criteria;
performing a first search based on the first search criteria;
generating the candidate search element based on a result of the first search;
storing information on the set or revised search criteria in association with information on the first search criteria;
receiving subsequent search criteria;
determining that the subsequent search criteria sufficiently match the first search criteria;
performing a search according to the subsequent search criteria; and
modifying, based on the stored information on the set or revised search criteria, at least one of:
the search according to the subsequent search criteria, or
a display of results according to the subsequent search criteria.

13. A method of controlling a search engine, comprising:
receiving a search result from the search engine, the search result including at least one hit and further including summary information for each hit;
causing at least one hit and corresponding summary information to be displayed on a display;
receiving input indicating selection of an element from the summary information using a pointing device in connection with the display;
and revising search criteria for use by the search engine by revising the treatment of the selected element in a subsequent search by the search engine.

14. A method of searching comprising:
receiving first search criteria;
performing a first search based on the first search criteria;
receiving second search criteria that refine the first search criteria;
storing information on the second search criteria in association with information on the first search criteria;
receiving subsequent search criteria;
determining that the subsequent search criteria sufficiently match the first search criteria;
performing a search according to the subsequent search criteria; and
modifying, based on the stored information on the second search criteria, at least one of:
the search according to the subsequent search criteria, or
a display of results according to the subsequent search criteria.

15. A device arranged to perform the method of claim 1.

16. (canceled)

17. A non-transitory machine readable storage medium storing a computer program, that, when executed, is to cause a processing device to perform the method of claim 1.

18. (canceled)

19. (canceled)

20. (canceled)

21. (canceled)

22. A device arranged to perform the method of claim 13.

23. A device arranged to perform the method of claim 14.
